(19) United States
(12) Patent Application Publication
(10) Pub. No.: US 2008/0306682 A1
(43) Pub. Date: Dec. 11, 2008

(54) SYSTEM SERVING A REMOTELY ACCESSIBLE PAGE AND METHOD FOR REQUESTING NAVIGATION RELATED INFORMATION

(75) Inventors: Walter A. Dorfstatter, Northville, MI (US); James J. Piwowarski, Holly, MI (US); Steven J. Ross, Livonia, MI (US); Richard A. Johnson, Rochester Hills, MI (US)

Correspondence Address: Julia Church Dierker;Dierker & Associates, P.C., 3331 W. Big Beaver Road, Suite 109, Troy, MI, 48084-2813, US

(73) Assignee: GENERAL MOTORS CORPORATION, DETROIT, MI (US)

(21) Appl. No.: 12/113,142

(22) Filed: Apr. 30, 2008

Related U.S. Application Data
(63) Continuation-in-part of application No. 11/758,213, filed on Jun. 5, 2007.

(51) Int. Cl. G01C 21/00; H04Q 7/20

(52) U.S. Cl. 701/207; 701/200; 455/456.1

(57) ABSTRACT

A system for sharing destinations includes a communications device for transmitting a destination location and a designated recipient of the destination location. The system further includes a call center including an advisor configured to receive the destination location and the designated recipient of the destination location, a communications system operable by the advisor for pushing a message to an electronic device of the designated recipient regarding the destination location, and a central computer system operable by the advisor for identifying in a profile of the designated recipient that the destination location has been shared.

### CROSS-REFERENCE TO RELATED APPLICATION

This application is a continuation-in-part of U.S. patent application Ser. No. 11/758,213, filed Jun. 5, 2007, which is incorporated herein by reference in its entirety.

### TECHNICAL FIELD

The present disclosure relates generally to a system serving a remotely accessible page and methods for requesting navigation related information.

### BACKGROUND

Personalized vehicle navigational directions formulated for a route, having a predetermined starting location and predetermined destination location, have become increasingly popular. Many vehicle operators utilize vehicle navigational directions that are based upon an operator-identified starting location and an operator-identified destination location. In one system, a vehicle location detection system determines the current location of the vehicle, which is utilized as the starting position, and an in-vehicle operator utilizes an in-vehicle user interface panel to input the destination location. In another system, a user may utilize an Internet interface to identify a starting location and a destination location, from which the system may formulate navigational directions. In yet another system, a user may utilize a mobile telephone to input a destination location, and then may receive navigational directions from the mobile telephone's current location to the destination location via the mobile telephone.

In in-vehicle navigation systems where the starting location is the vehicle's location, as detected by a location detection system, and an in-vehicle operator inputs the destination location at the in-vehicle user interface panel, the navigational options presented to the user (e.g., selecting the shortest route or the fastest route, avoiding freeways/expressways, etc.) and the ease of navigating through the navigation system (e.g., menus) may be limited by the in-vehicle user interface panel. In such a system, the user may be unable to request navigational directions in advance. As an example, the user may be unable to request the formulation of navigational directions to be delivered at a predetermined or to-be-determined time. As another example, the user may also be unable to request the formulation of navigational directions before the vehicle is in a desired starting location.

In in-vehicle navigation systems where a user requests the navigational directions from a location remote from the vehicle via the Internet, the user is typically required to input both a starting location and a destination location before navigational directions are formulated. It is recognized that “cookies” or other similar digital files stored locally on a computer may allow the computer to recall previously entered starting and/or destination locations, however, such information recall may be limited to locations previously input on a particular computer.

In navigation systems where the starting location is the current location of a mobile phone and the destination location is input in the mobile telephone, the navigational directions are delivered to the mobile phone. It is recognized that inputting the destination location into a mobile telephone may suffer from some of the same drawbacks as described hereinabove with respect to inputting a destination location into an in-vehicle user interface panel. Additionally, the user generally is limited by the location of the mobile phone. Since the starting location is determined by the position of the mobile phone, vehicle navigational directions may be achieved when the user's mobile phone is located in the vehicle (or in close proximity thereto).

### SUMMARY

A system for sharing destinations includes a communications device for transmitting a destination location and a designated recipient of the destination location. The system further includes a call center including an advisor configured to receive the destination location and the designated recipient of the destination location, a communications system operable by the advisor for pushing a message to an electronic device of the designated recipient regarding the destination location, and a central computer system operable by the advisor for alerting a profile of the designated recipient indicating the destination location has been shared.

### BRIEF DESCRIPTION OF THE DRAWINGS

Features and advantages the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a vehicle navigation system;

FIG. 2 is a flow diagram depicting an example of a method for requesting navigation related information;

FIG. 3 depicts an example of a remotely accessible page used in examples of the method and system;

FIG. 4 is a flow diagram depicting examples of the method for requesting navigation related information;

FIGS. 5A through 5E depict examples of a remotely accessible page as a user navigates through an example of the method;

FIG. 6 is a flow diagram depicting examples of the method for sharing a destination location; and

FIG. 7 depicts an example of a remotely accessible page for sharing destinations.

### DETAILED DESCRIPTION

Example(s) of the present disclosure address one or more of the drawbacks enumerated above by providing a system that enables a user to request vehicle navigational directions at a location remote from the vehicle, and then retrieve such directions when located in the vehicle. Other example(s) of the present disclosure enable a user to input destination locations at a location remote from the vehicle, and then request vehicle navigational directions using such previously stored destination locations. Still other example(s) of the present disclosure enable a user to request vehicle navigational directions at a location remote from the vehicle using a current or stored vehicle location and an input destination location. Yet other example(s) of the present disclosure enable a user to share a destination location with one or more designated recipients. As such, example(s) of the system and methods discussed herein advantageously provide for improved formulation and/or delivery of vehicle navigational directions.

It is to be understood that, as defined herein, the term “user” includes vehicle owners, operators, and/or passengers. It is to be understood that the term “user” may be used interchangeably with subscriber/service subscriber.

Still further, it is to be understood that the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. As such, indirect communication may include communication between two components with additional component(s) located therebetween.

The term “navigation function” includes a program that enables a user to request, obtain and/or save destination entries, navigational directions, maps, and/or the like. The navigation function is executed, for example, by a server, a communications device, and/or a call center in combination with a computer based location mapping system, a computer based navigation system, and/or the like, and/or combinations thereof.

It is to be further understood that, as used herein, “navigational directions” include a series of maneuvers configured to direct a vehicle along a navigational route. As such, in accordance with such definitions, the terms navigational directions and navigational route may be used interchangeably herein. Additionally, “navigational directions” and “navigational route” may be used interchangeably herein with “vehicle navigational directions” and “vehicle navigational route,” respectively.

Additionally, the term “destination function” refers to a program that enables a user to select whether he/she wants to share a destination. If, for example, the user selects that he/she wants to share the destination, the user is allowed to select one or more designated recipients of the shared destination. As used herein, a “designated recipient” is a person or entity other than the user that is permitted, based on the user and/or the recipient's discretion, to receive information (e.g., navigational directions) pertaining to the shared destination.

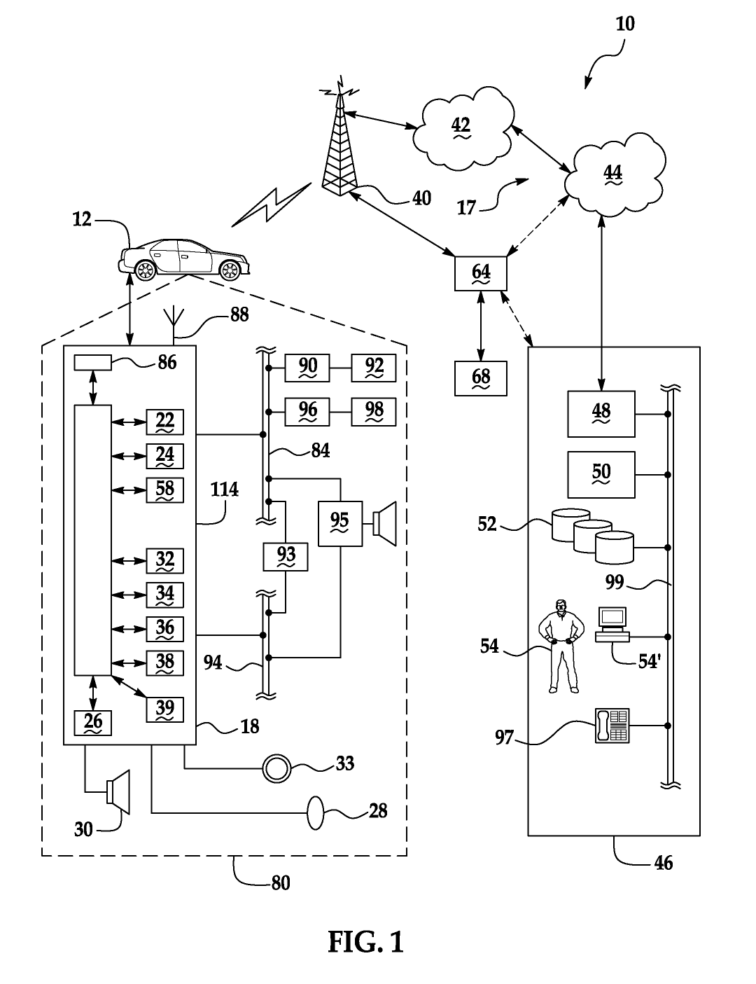

Referring now to FIG. 1, the system 10 includes a vehicle 12, a vehicle communications network 14, a telematics unit 18, a wireless communication system 17 (including, but not limited to, one or more cell towers 40, one or more base stations and/or mobile switching centers (MSCs) 42, one or more land networks 44, one or more service providers (not shown)), and one or more call centers 46. In an example, the wireless carrier/communication system 17 is a two-way radio frequency communication system. In another example, the wireless carrier/communication system 17 includes one or more servers 64 operatively connected to a remotely accessible page 68 (e.g., a webpage).

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car truck, recreational vehicle (RV), boat, plane, etc., and is equipped with suitable hardware and software that enables it to communicate (e.g., transmit and/or receive voice and data communications) over the wireless carrier/communication system 17. It is to be understood that the vehicle 12 may also include additional components 16 suitable for use in the telematics unit 18.

Some of the vehicle hardware 80 is shown generally in FIG. 1, including the telematics unit 18 and other components that are operatively connected to the telematics unit 18. Examples of such other hardware 80 components include a microphone 28, a speaker 30 and buttons, knobs, switches, keyboards, and/or controls 33. Generally, these hardware 80 components enable a user to communicate with the telematics unit 18 and any other system 10 components in communication with the telematics unit 18.

Operatively coupled to the telematics unit 18 is a network connection or vehicle bus 84. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 84 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 18 is an onboard device that provides a variety of services, both individually and through its communication with the call center 46. The telematics unit 18 generally includes an electronic processing device 20 operatively coupled to one or more types of electronic memory 26, a cellular chipset/component 86, a wireless modem 22, a navigation unit containing a location detection (e.g., global positioning system (GPS)) chipset/component 24, a mobile telephone 32, a real-time clock (RTC) 34, a TTY unit 36, a short-range wireless communication network 38 (e.g., a Bluetooth® unit), a user display panel 39, and/or a dual antenna 88. In one example, the wireless modem 22 includes a computer program and/or set of software routines executing within processing device 20.

In an example, the user display panel 39 is equipped with user interface capabilities and, thus, may operate as a user interface panel. As such, the display panel 39 may include one or more input devices or components such as, for example, one or more buttons, knobs, and/or microphones. As non-limiting examples, an input device on the display panel 39 may be utilized to request communication with a call center 46 and/or the server 64 and/or to effectively communicate therewith. A user may, for example, request transmission of vehicle navigational directions by pushing a button or speaking into a microphone operatively disposed on the display panel 39.

It is to be understood that the telematics unit 18 may be implemented without one or more of the above listed components, such as, for example, the short-range wireless communication network 38. It is to be further understood that telematics unit 18 may also include additional components and functionality as desired for a particular end use.

The electronic processing device 20 may execute various computer programs that interact with operational modes of electronic and mechanical systems within the vehicle 12. In an example, the electronic processing device 20 may be a micro controller, a controller, a microprocessor, a host processor, and/or a vehicle communications processor. In another example, electronic processing device 20 may be an application specific integrated circuit (ASIC). Alternatively, electronic processing device 20 may be a processor working in conjunction with a central processing unit (CPU) performing the function of a general-purpose processor. It is to be understood that the electronic processing device 20 controls communication (e.g., signals, such as call signals) between telematics unit 18, cell towers 40, call center 46, server 64, another party, and/or combinations thereof.

Further, the electronic processing device 20 may generate and accept digital signals transmitted between the telematics unit 18 and the vehicle communications network 14, which is connected to various electronic modules in the vehicle 12. In one example, these digital signals activate the programming mode and operation modes within the electronic modules, as well as provide for data transfer between the electronic modules. In another example, certain signals from the electronic processing device 20 may be translated into vibrations and/or visual alarms.

The location detection chipset/component 24 may include a Global Position System (GPS) receiver, a radio triangulation system, a dead reckoning position system, and/or combinations thereof In particular, a GPS receiver provides accurate time and latitude and longitude coordinates of the vehicle 12 responsive to a GPS broadcast signal received from a GPS satellite constellation (not shown).

The cellular chipset/component 86 may be an analog, digital, dual-mode, dual-band, multi-mode and/or multi-band cellular phone.

Also associated with electronic processing device 20 is the previously mentioned real time clock (RTC) 34, which provides accurate date and time information to the telematics unit 18 hardware and software components that may require and/or request such date and time information. In one example, the RTC 34 may provide date and time information periodically, such as, for example, every ten milliseconds.

The telematics unit 18 provides numerous services, some of which may not be listed herein. Several examples of such services include, but are not limited to: turn-by-turn directions and other navigation-related services provided in conjunction with the GPS based chipset/component 24; airbag deployment notification and other emergency or roadside assistance-related services provided in connection with various crash and/or collision sensor interface modules 90 and sensors 92 located throughout the vehicle 12; and infotainment-related services where music, Web pages, movies, television programs, videogames and/or other content is downloaded by an infotainment center 93 operatively connected to the telematics unit 18 via vehicle bus 84 and audio bus 94. In one non-limiting example, downloaded content is stored (e.g., in memory 26) for current or later playback.

Again, the above-listed services are by no means an exhaustive list of all the capabilities of telematics unit 18, but are simply an illustration of some of the services that the telematics unit 18 is capable of offering.

Vehicle communications preferably use radio transmissions to establish a voice channel with wireless carrier system 17 such that both voice and data transmissions may be sent and received over the voice channel. Vehicle communications are enabled via the cellular chipset/component 86 for voice communications and the wireless modem 22 for data transmission. In order to enable successful data transmission over the voice channel, wireless modem 22 applies some type of encoding or modulation to convert the digital data so that it can communicate through a vocoder or speech codec incorporated in the cellular chipset/component 86. It is to be understood that any suitable encoding or modulation technique that provides an acceptable data rate and bit error may be used with the examples disclosed herein. Generally, dual mode antenna 88 services the location detection chipset/component 24 and the cellular chipset/component 86.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 18 or can be part of a vehicle audio component 95. In either event and as previously mentioned, microphone 28 and speaker 30 enable vehicle hardware 80 and call center 46 to communicate with the occupants through audible speech. The vehicle hardware 80 also includes one or more buttons, knobs, switches keyboards, and/or controls 82 for enabling a vehicle occupant to activate or engage one or more of the vehicle hardware components. In one example, one of the buttons 82 may be an electronic pushbutton used to initiate voice communication with the call center 46 (whether it be a live advisor 54 or an automated call responsive system 54′). In another example, one of the buttons 82 may be used to initiate emergency services.

The audio component 95 is operatively to the vehicle bus 84 and the audio bus 94. The audio component 95 receives analog information, rendering it as sound, via the audio bus 94. Digital information is received via the vehicle bus 84. The audio component 95 provides AM and FM radio, satellite radio, CD, DVD, multimedia and other like functionality independent of the infotainment center 93. Audio component 95 may contain a speaker system, or may utilize speaker 30 via arbitration on vehicle bus 84 and/or audio bus 94. The audio component 95 may also include software for receiving alerts from other vehicles 12 using the method(s) disclosed herein.

The vehicle crash and/or collision detection sensor interface 90 is/are operatively connected to the vehicle bus 84. The crash sensors 92 provide information to the telematics unit 18 via the crash and/or collision detection sensor interface 90 regarding the severity of a vehicle collision, such as the angle of impact and the amount of force sustained.

Other sensors 98, connected to various sensor interface modules 96, are operatively connected to the vehicle bus 84. Example vehicle sensors 98 include, but are not limited to, gyroscopes, accelerometers, magnetometers, emission detection and/or control sensors, and/or the like. Non-limiting example sensor interface modules 96 include powertrain control, climate control, body control, and/or the like.

In a non-limiting example, the vehicle hardware 80 includes a display 39, which may be operatively connected to the telematics unit 18 directly, or may be part of the audio component 95. Non-limiting examples of the display 39 include a VD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 17 may be a cellular telephone system and any other suitable wireless system that transmits signals between the vehicle hardware 80 and land network 44. According to an example, wireless carrier/communication system 17 includes one or more cell towers 40, base stations and/or mobile switching centers (MSCs) 42, as well as any other networking components required to connect the wireless system 17 with land network 44 (as discussed above). It is to be understood that various cell tower/base station/MSC arrangements are possible and could be used with wireless system 17. For example, a base station 20 and a cell tower 40 may be co-located at the same site or they could be remotely located, and a single base station 42 may be coupled to various cell towers 40 or various base stations 42 could be coupled with a single MSC 42. A speech codec or vocoder may also be incorporated in one or more of the base stations 42, but depending on the particular architecture of the wireless network 17, it could be incorporated within a Mobile Switching Center 42 or some other network components as well.

Land network 44 may be a conventional land-based telecommunications network that is connected to one or more landline telephones and connects wireless carrier/communication network 17 to call center 46. For example, land network 44 may include a public switched telephone network (PSTN) and/or an Internet protocol (IP) network. It is to be understood that one or more segments of the land network 44 may be implemented in the form of a standard wired network, a fiber of other optical network, a cable network, other wireless networks such as wireless local networks (WLANs) or networks providing broadband wireless access (BWA), or any combination thereof.

Call center 46 is designed to provide the vehicle hardware 80 with a number of different system back-end functions and, according to the example shown here, generally includes one or more switches 48, communication services managers 50, databases 52, live and/or automated advisors 54, 54′, as well as a variety of other telecommunication and computer equipment 97 that is known to those skilled in the art. In an example, the telecommunication and computer equipment 97 includes a central computer system operable by the advisor 54, 54′. These various call center components are coupled to one another via a network connection or bus 99, such as the one (vehicle bus 84) previously described in connection with the vehicle hardware 80.

The live advisor 54 may be physically present at the call center 46 or may be located remote from the call center 46 while communicating therethrough.

Switch 48, which may be a private branch exchange (PBX) switch, routes incoming signals so that voice transmissions are usually sent to either the live advisor 54 or an automated response system 54′, and data transmissions are passed on to a modem or other piece of equipment (not shown) for demodulation and further signal processing. The modem preferably includes an encoder, as previously explained, and can be connected to various devices such as the server 64 and database 52. For example, database 52 may be designed to store subscriber profile records, subscriber behavioral patterns, or any other pertinent subscriber information. Although the illustrated example has been described as it would be used in conjunction with a manned call center 46, it is to be appreciated that the call center 46 may be any central or remote facility, manned or unmanned, mobile or fixed, to or from which it is desirable to exchange voice and data communications.

It is to be understood that, although a service provider (not shown) may be located at the call center 46, the call center 46 is a separate and distinct entity from the service provider. In an example, the service provider is located remote from the call center 46. A service provider provides the user with telephone and/or Internet services. The service provider is generally a wireless carrier (such as, for example, Verizon Wireless®, AT&T®, Sprint®, etc.). It is to be understood that the service provider may interact with the call center 46 to provide service(s) to the user.

The server 64 may be operatively connected to at least the cell towers 40. In an alternative example, the server 64 is directly or operatively connected to the land network 44 or the call center 46 (illustrated by the phantom lines). It is to be understood that the telematics unit 18 may be in communication with the server 64 via the cell towers 40 alone, or via the communication network 42, land network 44, and/or the call center 46.

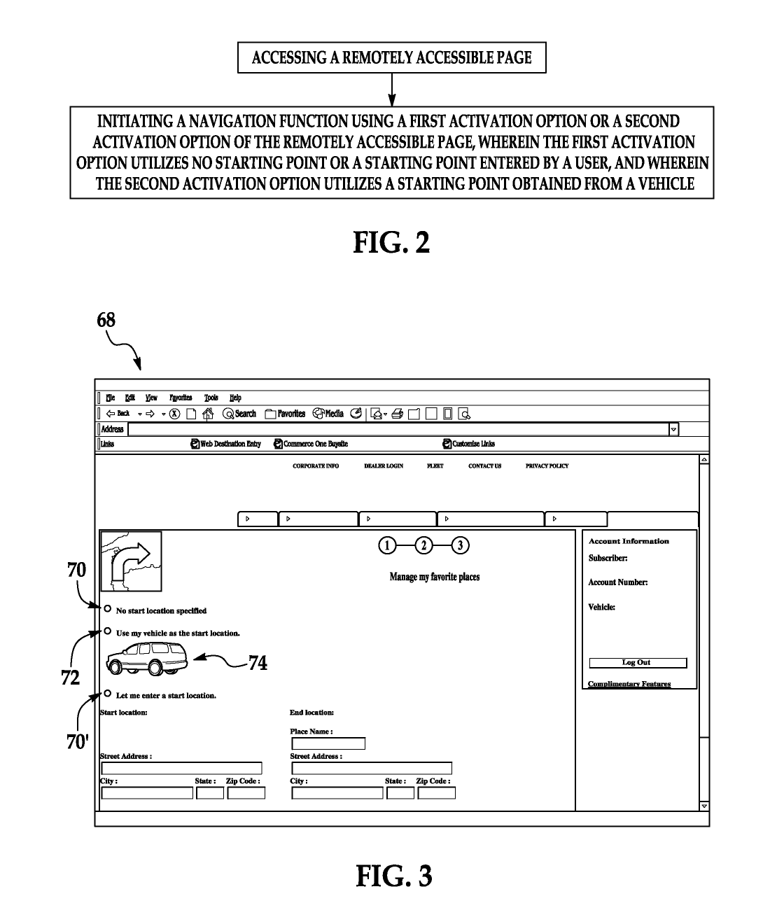

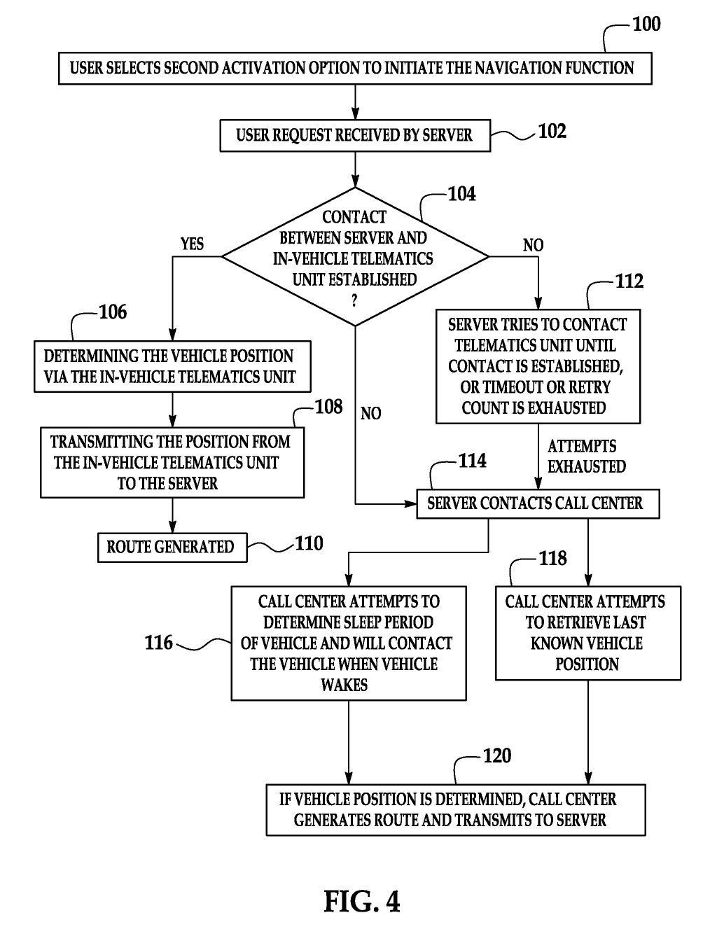

Referring now to FIGS. 2 and 3 together, an example of the method (see FIG. 2) for requesting navigation related information, and an example of a remotely accessible page 68 (see FIG. 3) used in performing such a method are depicted. The method shown in FIG. 2 generally includes accessing the remotely accessible page 68; and initiating a navigation function using a first activation option or a second activation option of the remotely accessible page 68.

The remotely accessible page 68 shown in FIG. 3 includes the first activation option 70, 70′ and the second activation option 72. The first activation option 70, 70′ includes two entry spaces, one of which triggers the navigation function to proceed with no starting point (see reference numeral 70), and the other of which, when selected, triggers the navigation function to proceed with a user entered starting point (see reference numeral 70′). The second activation option 72 includes one entry space, which, when selected, triggers the navigation function to proceed with a starting point obtained from the vehicle 12.

Generally, the remotely accessible page 68 is supported and hosted by the server 64. In an example, the remotely accessible page 68 is accessible to the user via a computer or other device (e.g., desktop, notebook, mobile phone, or personal digital assistant) configured to access the Internet. In an example, the computer or other device includes, or is in communication with, an input device (e.g., a keyboard and/or mouse) and a display (e.g., a monitor and/or one or more speakers). It is to be understood that the communication between the computer or other device and the server 64 may be wired and/or wireless.

The computer or other device is generally at a location that is remote from the vehicle 12. The user may access a personalized account at the remotely accessible page 68 by inputting user-specific information at the page 68. The user specific information may include, for example, the user's name, a password, an account number, and/or any other identifying information. It is to be understood that the personalized account information may be stored and/or accessed by the server 64 or by the call center 46.

In an example, the remotely accessible page 68 may also include personalized graphical and/or textual indicia 74 representing the vehicle 12 associated with the user. As shown in FIG. 3, the graphical indicia 74 includes a representation of the make and model of the vehicle 12 associated with the specific user account that is accessed.

In one example of the method, the user selects the first activation option 70 utilizing no starting point. Generally, in this example, a user is interested in obtaining a map of a desired destination location, or is interested in storing preferred destination locations within their account. As such, a starting point may be unnecessary.

In this example, after selecting the first activation option 70 utilizing no starting point, a user is prompted to enter a destination location. In one example, the server 64, via a location mapping system operatively connected thereto and in response to receiving the destination location, may generate a map including the destination location. The characteristics of the map may be determined by the mapping system and/or based on the information input by the user. For example, a user may request the location of a baseball stadium within ten miles of a particular city. The generated map is presented to the user via the remotely accessible page 68. At this point, the page 68 may also include an option for the user to obtain navigational directions to the entered destination location.

In another example, the user is asked if he/she would like to save the entered destination location as a preferred destination within his/her account. The user may store the destination location under a desirable name. In this example, the saved destination locations are associated with the user and/or the vehicle 12. In an example, the saved destination locations are operatively stored in the server 64 and/or in communication services database(s) 52 of call center 46. The communication services database(s) 52 may also store information indicative of the association between the saved destination locations and a subscriber account/subscriber vehicle 12. When prompted by the user for the saved locations, the server 64 accesses the list or communicates with the call center 46 to obtain such information from the database(s) 52. As a non-limiting example, a user may be required to log-in to the remotely accessible page 68 and server 64 using a unique password, which indicates to the database(s) 52 the particular subscriber account/subscriber vehicle 12 requesting the information, thereby enabling the call center 46 to retrieve and transmit the corresponding list to the user (via the server 64).

The saved destination locations may be useful for subsequent direction requests, and they may be uploaded to the vehicle 12, for example, when the vehicle 12 is started and/or when the user requests (either verbally or via the display panel 39) navigational instructions to one of the saved destination locations. In one example, the telematics unit 18 queries the server 64 for any recent destination locations input via the remotely accessible page 68. The user may then select previously stored destinations from within the vehicle 12, for example, verbally or via display panel 39. It is to be understood that destination locations entered using the telematics unit 18 (e.g., via display panel 39) may also be uploaded to the server 64, thereby enabling synchronization between the two 18, 64.

In another example of the method, the user selects the first activation option 70′, which utilizes a user entered starting point. Generally, in this example, a user enters a starting point and a destination location. Upon receiving the information, the server 64 (via a route generation engine operatively connected thereto) generates a route from the starting point to the destination location or requests that the call center 46 (via a route generation engine operatively connected thereto) generate such a route. After the route is generated, the remotely accessible page 68 may inform the user that the route has been generated and is available for immediate or subsequent download. In one example, the user may select to have the route transmitted (e.g., for printing) via the remotely accessible page 68. In another example, the remotely accessible page 68 may provide the user with instructions for downloading the generated route once in the vehicle 12. In the latter example, the route may be stored at the server 64 or at the call center 46 until the user requests the route from within the vehicle 12 (described further hereinbelow).

In this and other examples disclosed herein, the starting point and/or destination location may be manually entered by the user, or may be selected from a list of predetermined starting and/or destination locations operatively stored with/at/in 1) the user's computer, 2) the remotely accessible page 68 (via server 64), 3) the call center 46, and/or 4) the user's account. In the latter three examples, the list of starting points and/or destination locations is stored at a location remote from the computer or other device being used to access the remotely accessible page 68. As such, the list may be accessible to a user from any device capable of accessing the remotely accessible page 68. In another example, the list is stored locally at the device where the starting positions and/or destination locations were previously input or detected. In such an example, an abbreviated list may be accessible at any single device, the abbreviated list including those starting points or destination locations that were input or detected at that particular device.

The user may save preferred starting and/or destination locations (as previously described), or the server 64 may compile the list from one or more destination locations and/or starting locations that were previously input by the user. In an example, the server 64 adds each destination location and/or starting location to the list of predetermined destination locations when it is input or detected. In another example, the server 64 adds an input destination location or starting location to the list when prompted to do so by a user. In yet another example, the server 64 is configured to add a destination location or a starting location to the list of predetermined destination locations once the destination location or starting location has been input or detected a predetermined number of times. As non-limiting examples, the predetermined number of times may be two, three, four, five, etc.

It is to be understood that the list of destination locations may also be non-user specific. Lists of restaurants, churches, theaters, stadiums/arenas, and/or the like may be available to a user to select the destination location. Such lists may be organized via geographic areas.

In one example, the user may enter the starting point and/or destination location as a complete or partial address and/or as a complete or partial name (e.g., a family name for a residence or a business name for a commercial establishment). If the entry is a partial address or partial name, the server 64 may assume a complete name or address therefrom, or may prompt the user to select one or more complete names or addresses from one or more that are provided to the user. Additionally, the server 64 may recognize one or more points of interest within a predetermined distance from the starting location, one of which may be utilized as the destination location. In an example, the server 64 receives a point of interest category (e.g., restaurant, gas station, hotel, airport, etc.) that is input by a user at the remotely accessible page 68, and responds by providing the user with the points of interest that fall within the input category, and that are located within a predetermined distance from the starting point.

The predetermined distance between the starting point and the various points of interest may delineate a predetermined area, which may be defined as a geometric shape that includes the starting point as a center. In an example, the predetermined area is a circle having a radius that corresponds to the distance between the furthest point of interest and the starting point. As such, the starting point is disposed substantially at the center of the circle. In another example, the predetermined distance (or radius) may be a default value determined by the server 64 and/or may by the user. As non-limiting examples, the predetermined distance may be 1 mile, 5 miles, 10 miles, 20 miles, 50 miles, or 100 miles.

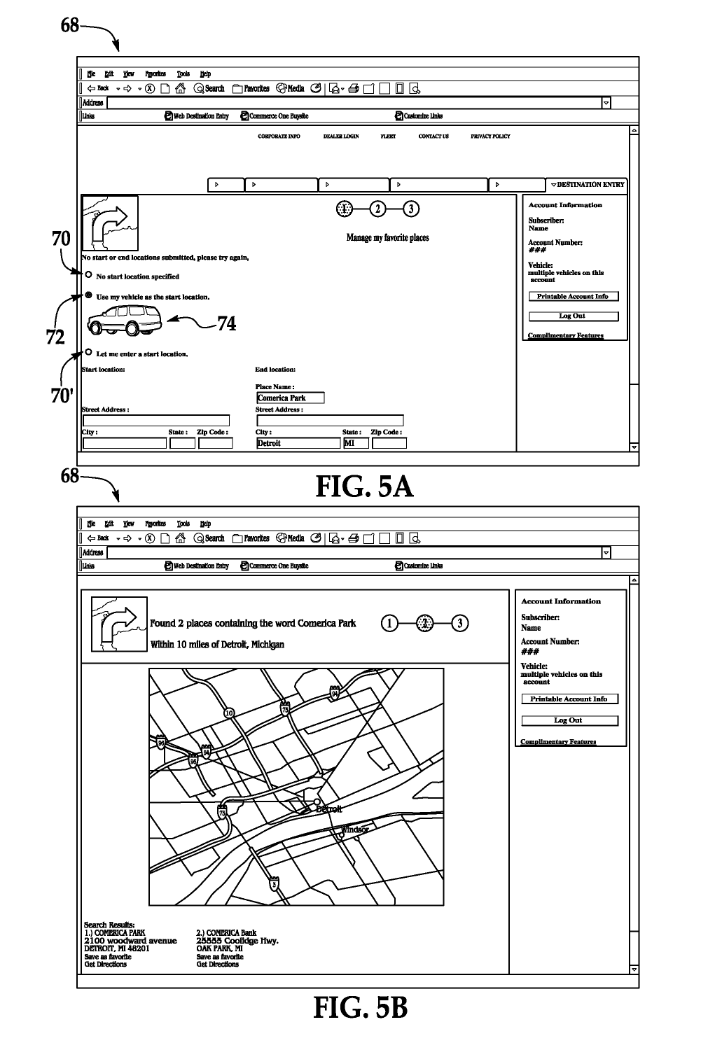

Referring now to FIG. 4, in still other examples of the method, the user selects the second activation option 72 (shown as reference numeral 100) which utilizes a starting point obtained from the vehicle 12. Generally, when the user selects the second activation option 72, the server 64 recognizes the request (shown as reference numeral 102) to obtain the vehicle's current or recent location. The server 64 attempts to communication with the telematics unit 18 (shown as reference numeral 104) to obtain the vehicle position, which is then used as a starting point to generate the requested route.

In one example, attempts to determine the position of the vehicle 12 are initiated substantially simultaneously or sequentially with the time that the destination location is input into the server 64 by the user. In another example, the server 64 attempts to determine the position of the vehicle as soon as the user logs into the program. In still another example, the current location of the vehicle 12 is transmitted from the telematics unit 18 when the user selects the second activation option 72. As such, the server 64 may have access to the vehicle location before and/or after the user selects the second activation option 72.

In one example, in response to the user selecting the second activation option 72, the server 64 initiates a request for the vehicle position. The server 64 begins by requesting direct communication with the telematics unit 18. As previously described, the server 64 is in operative communication with the telematics unit 18 via at least the wireless carrier system 40. Such operative communication enables the server 64 to communicate with the location detection system 24 located within the telematics unit 18 if a connection is established between the server 64 and the telematics unit 18.

In one of the examples shown in FIG. 4, the server 64 establishes communication with the telematics unit 18. In this example, the server 64 queries the telematics unit 18 for the vehicle position, and in response, the location detection system 24 detects the current vehicle position, as shown at reference numeral 106. The telematics unit 18 then transmits the detected vehicle position to the server 64, as shown at reference numeral 108.

The location of the vehicle 12 received by the server 64 is utilized as the starting point for formulating the user requested navigational directions. The server 64 then generates a full or partial route, and informs the user (via the remotely accessible page 68) that the route is ready for immediate and/or subsequent downloading. In examples of the method in which a partial route is generated and stored, it is to be understood that the previously calculated and stored initial maneuvers are delivered to the vehicle 12 upon request of the route, and when the user begins to traverse the route, the remaining maneuvers are generated and transmitted to the vehicle 12.

In the other example shown in FIG. 4, the server 64 fails to establish communication with the telematics unit 18. It is to be understood that successive attempts to contact the telematics unit 18 may be made until a position is determined (at which time a route may be generated, see reference numeral 120), or until a timeout or retry count is exhausted, as shown at reference numeral 112. The timeout or retry count may be any desirable time or number. In this example, the user may be informed of the status of obtaining the vehicle position.

If contact between the server 64 and in-vehicle telematics unit 18 is not achieved, or if attempts to contact the vehicle 12 are exhausted, the server 64 may contact the call center 46 and request the vehicle position from the call center 46, as shown at reference numeral 1 14. In one example, as shown at reference numeral 1 16, the call center 46 attempts to determine the discontinuous receive or sleep cycle of the vehicle 12. The call center 46 then attempts to contact the vehicle 12 and retrieve its position when the vehicle 12 is turned on. For example, if an awake period is determined during a vehicle discontinuous receive or sleep cycle, the call center 46 may attempt to synchronize communication with the vehicle during the awake period in order to extract the vehicle position. Generally, the vehicle position may be extracted if the location detection system 24 is active during the awake period.

In still another example, as shown at reference numeral 118, the call center 46 may query a memory location (e.g., in-vehicle memory 26 or a database at the call center 46) where previously determined vehicle positions are stored. As a non-limiting example, the last known vehicle position may be extracted from the memory location and used as the starting point for formulating the requested navigation directions. The call center 46 may also check a location detection system 24 quality indicator that indicates the quality of the stored positions.

In one example, a route-generating engine at the call center 46 calculates a full or partial route (see reference numeral 120) using the vehicle position extracted from the memory location and the destination location input by the user at the remotely accessible page 68. The call center 46 may inform the server 64 that the route has been generated, and in response, the server 64 may inform the user that the route is being stored for subsequent download. In such examples, the call center 46 may store the route for transmission to the vehicle 12 upon receiving a subsequent request. The call center 46 may also transfer the generated route to the server 64 for presentation to the user via the remotely accessible page 68.

Obtaining vehicle positions using the remotely accessible page 68 advantageously enables a full or partial route to be generated in advance of a user being present in the vehicle 12. The user may then be informed, via the remotely accessible page 68, that the full or partial route has been generated. The user may also be presented with instructions on how to retrieve the generated route when in the vehicle 12.

It is to be understood, in any of the examples disclosed herein, that one or more set of navigational directions may be generated and presented to the user via the remotely accessible page 68. From this list, the user may select a particular set of navigational directions along a preferred navigational route. The user may then select the preferred navigational route. As non-limiting examples, the user may select the preferred navigational route based, at least partially, upon: the length of the navigational route(s); the estimated time to travel the navigational route(s); the amount of expressway travel included in the navigational routes(s); the amount of toll required to travel the navigational route(s); and/or the number of identified points of interest along the navigational route(s); and/or combinations thereof. In this example, once a preferred navigational route has been selected, if required, the navigational directions associated with the preferred navigational route are formulated for transmittal to the user/vehicle.

In any of the examples disclosed herein which result in the formulation of partial or full navigation directions, the navigational directions are transmitted to the vehicle 12 in response to a demand therefor. As such, the server 64 and/or the call center 46 may save the generated instructions until the user demands such instructions/directions. Furthermore, the saved instructions may be updated if the user moves the vehicle 12 prior to demanding the instructions. Upon a user request from the vehicle 12 for such previously generated instructions, the server 64 and/or call center 46 may query for an updated vehicle position to ensure that the previously generated instructions are still accurate.

The server 64 and/or call center 46 may transmit the formulated navigational directions to the in-vehicle telematics unit 18 via at least the wireless carrier system 40. In an example, the navigational directions are transmitted through the land network 44 before passing through the communication network 42 and the wireless carrier system 40 to the telematics unit 18.

As a non-limiting example, the navigational directions may be demanded by a user via in-vehicle display panel 39. In this example, the current location of the vehicle 12 is determined at the time of the demand for the navigational directions. As a non-limiting example, a user may input a destination location into the server 64 via the remotely accessible page 68 and request the formulation of navigational directions from the vehicle's 12 then-current location to the input destination location. Then, at a later time, the user may demand (e.g., via the display panel 39) that those previously requested navigational directions be transmitted to the vehicle 12. In response to the demand for the navigational directions, the call center 46 will detect the current location of the vehicle 12, and will transmit the navigation instructions to the vehicle 12 if the pre-calculated instructions are accurate. If the vehicle position has changed, the call center 46 will regenerate and transmit the navigational instructions.

In an example, the navigational directions are transmitted to the telematics unit 18 in real-time. Generally, the telematics unit 18 may receive the navigational directions in a plurality of predetermined segments at predetermined intervals. More specifically, the navigational directions may be transmitted to the telematics unit 18 as a particular instruction is necessary (e.g., at a predetermined time before reaching a required vehicle maneuver) for the user to travel the navigational route. In another example, navigational directions are transmitted to the telematics unit 18 in their entirety. In such an example, the telematics unit 18 may transfer the navigational directions to the in-vehicle display panel 39 in real-time.

The in-vehicle display panel 39 may receive the navigational directions from the in-vehicle telematics unit 18 and may provide the navigational directions to an in-vehicle user. In an example, the navigational directions are provided to the user audibly, visually, and/or tactilely. As non-limiting examples, the user display panel 39 may display the navigational directions as one or more audio prompts, textual instructions, graphical maps, and/or vibrations. In an example, the vehicle speakers 30 are operatively embodied in the user display panel 39 such that the navigational directions may be transmitted as audio prompts from the telematics unit 18 to the display panel 39 for production over the vehicle speakers 30.

As non-limiting examples, providing the navigational directions to a user in real-time may be preferable for a navigational route delivered to a user audibly, and providing the navigational directions in their entirety may be preferable for a navigational route delivered to a user visually (e.g., a map displayed on the panel 39 screen). In yet another example, the navigational route is provided audibly and visually to a user from the display panel 39 (and, optionally, the speakers 30) substantially simultaneously or sequentially. Still further, tactile signals (e.g., vibrations at predetermined areas of the steering wheel) are delivered that are indicative of an upcoming maneuver. Generally, tactile signals are sent in conjunction with audio or visual navigation instructions.

In one or more examples disclosed herein, any current position of the vehicle 12 may be time dependent, and the time at which the position is detected may affect the formulated navigational directions. As such, the server 64 and/or the call center 46 may query the telematics unit 18 for an updated vehicle position at any time, for example, upon the occurrence of some triggering event. In one example, even when a user has not accessed the remotely accessible page 68, the server 64 and/or call center 46 may request vehicle position, for example, upon recognition of vehicle ignition initiation, or upon recognition of a wake up period of a discontinuous receive or sleep cycle. A user logging into his/her account may also trigger the server 64 and/or call center 46 to request an updated vehicle position. Furthermore, vehicle ignition initiation may trigger the telematics unit 18 to send its current position to the server 64 and/or call center 46. As such, if or when the user activates the second activation option 72, the server 64 and/or call center 46 is capable of updating the starting point with the most recently received position information. Periodic requests for vehicle position and storage of such information may be particularly useful for formulating navigation directions even when the telematics unit 18 is unreachable.

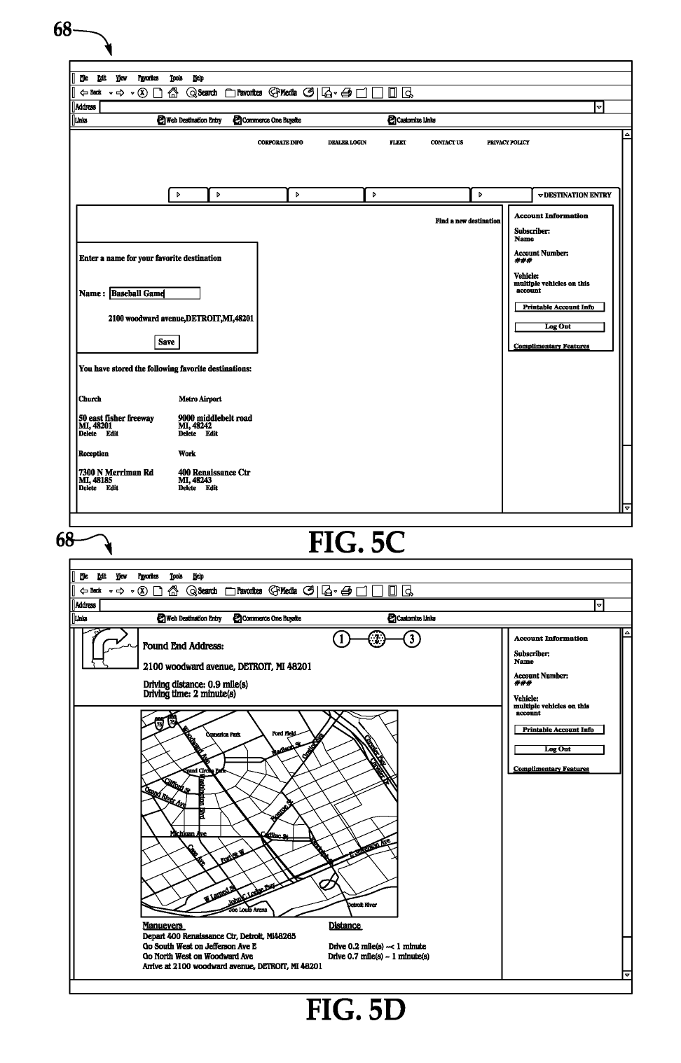

Referring now to FIGS. 5A through 5E, one example of the method is shown via different screens of the remotely accessible page 68. As shown in FIG. 5A, a user logs into his/her personal account, and is presented with the first and second activation options 70, 70′, 72. The remotely accessible page 68 also enables the user to input information regarding the starting point and the destination location. In this example, the user has selected the second activation option and has entered a destination location.

The server 64 receives the information and searches one or more databases for the entered destination entry. As shown in FIG. 5B, the server 64 may find more than one destination location that matches the user's entry. The user may then select to “get directions” for the desired destination from those listed. The user may also save one or more of the listed destinations as a preferred destination, as previously described.

As shown in FIG. 5C, the user selects to save one of the destination locations in his/her account as a favorite destination. As depicted, the user is prompted to enter a name for the destination. Upon doing so and clicking “save”, the selected destination location is saved in the user's account under the selected name. As shown in FIG. 5C, the user has previously saved four other favorite destination locations.

FIG. 5D depicts an example of the remotely accessible page 68 after the user selects one of the listed destinations. The server 64 uses examples previously described to determine the vehicle position (to use as a starting point) in accordance with the user's selection of the second activation option 72. FIG. 5D illustrates both text and a map of the calculated navigational directions. In the example shown in this series of figures, the server 64 is able to access a vehicle position to use as the starting point. More particularly, 400 Renaissance Ctr, Detroit, Mich. is determined by the system to be the starting point.

As depicted in FIG. 5E, the remotely accessible page 68 may also provide instructions for the user for retrieving the generated instructions when in the vehicle 12.

It is to be understood that receiving the current vehicle location in the manner disclosed herein may advantageously simplify the process of requesting vehicle navigational directions for a user by removing the step of manually entering the vehicle starting location.

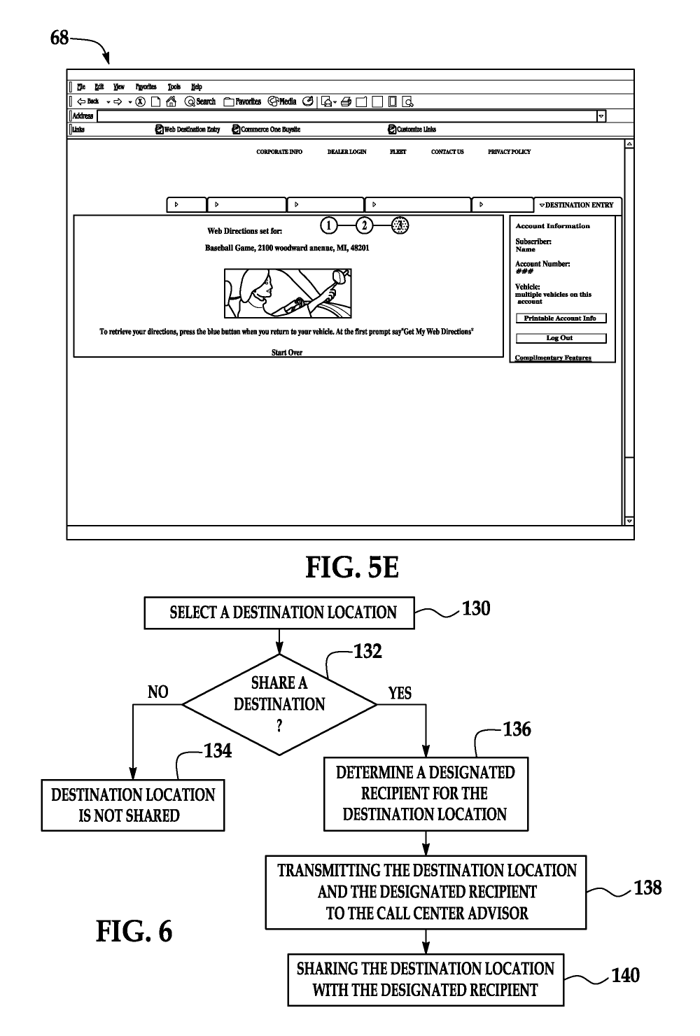

Also disclosed herein is a method of sharing a destination location with one or more designated recipients. With reference now to FIG. 6, the method begins by selecting a destination location (as shown by reference numeral 130). In an example, the destination location may be selected using a communications device such as, e.g., the telematics unit 18. In another example, the destination location may be selected using a computer (or other Internet-enabled device, such as a personal digital assistance (PDA)) located remote from and selectively operatively connected to the call center 46. The remotely located device is capable of accessing the remotely accessible page 68, as described above. If the destination location is selected using the remotely accessible page 68, any of the destination selection methods previously described in connection with FIGS. 2-4 may be used.

Once the user has selected a destination, the user decides whether he/she wants to share the destination with one or more designated recipients (as shown by reference numeral 132). After a user has decided to share his/her selected destination, he/she may indicate such a decision using the telematics unit 18 or the remotely accessible page 68, depending, at least in part on which was used to select the destination.

In an example, the user, via the telematics unit 18, establishes a connection with either the live 54 or automated 54′ advisor at the call center 46 through the communication network 14. The user then provides, to the advisor 54, 54′, the information pertaining to the destination location and that he/she wishes the destination location to be shared with one or more recipients.

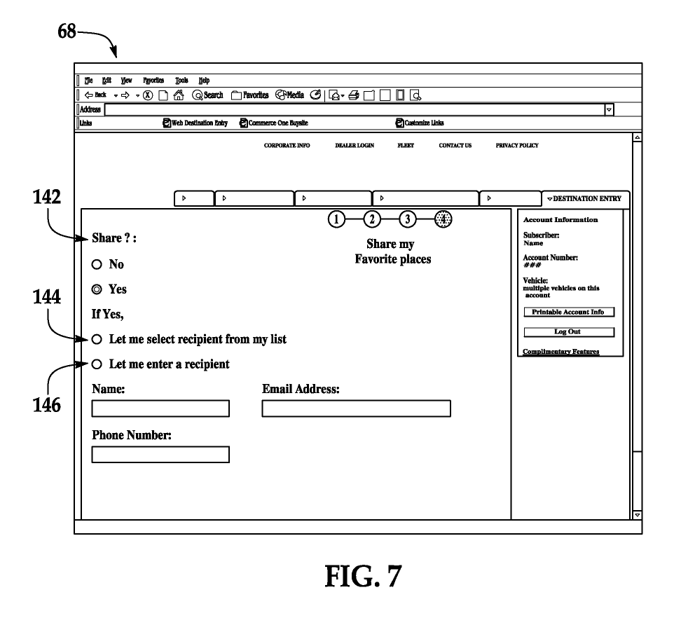

In another example, the user may be prompted via a share destination function 142 of the remotely accessible page 68 (see FIG. 7) with a question asking the user whether he/she would like to share the destination location. In response to the prompt, the user indicates on the remotely accessible page 68 that the destination should be either 1) shared, or 2) not shared. Such an indication may be accomplished by selecting, via a mouse click, a selection box indicating “yes,” if the destination is to be shared, or “no,” if the destination is not to be shared (see reference numeral 142 of FIG. 7).

Using either of the methods presented above, if the user elects not to share the destination location with one or more designated recipients, the user is given access to the destination location information, and the information is not shared with anyone else (as shown by reference numeral 134).

If, on the other hand, the user elects to share the destination location, the user then selects one or more designated recipients for the destination location. In an example, determining the designated recipient(s) for the destination location is accomplished using the communications device, such as, e.g., the telematics unit 18. In this example, the user may be presented with a list of designated recipients, from which the user may designate one or more persons or entities to share the destination location with.

The list of designated recipients is created by the user and is stored at the call center 46 (e.g., in the user's personal profile), in the telematics unit 18, or on the user's personal computer. Such a list may be created 1) using programs on the personal computer or the remotely accessible page 68, 2) by contacting the advisor 54, 54′ and requesting that one or more recipients be added to the user's profile, 3) by requesting that a number dialed from the in-vehicle phone be added to the user's profile, 4) by downloading or uploading one or more contacts from a user's address book (see, for example, U.S. patent application Ser. No. 11/959,140 filed Dec. 18, 2007 and Ser. No. 12/057,307 filed Mar. 27, 2008, both of which are incorporated herein by reference), or 5) combinations thereof. In a non-limitative example, the list may include a profile for each designated recipient, including contact information such as, e.g., a URL, one or more phone numbers, a name (or nickname), an e-mail address, and/or the like, and/or combinations thereof. If the list is stored at the call center 46, the list is stored in a user account/profile that is accessible by the user via the remotely accessible page 68 or by the telematics unit 18.

The user may also designate one or more recipients of the destination location by informing the advisor 54, 54′ of the designated recipient(s) when the destination location is selected. If one or more of the designated recipients are not presently on the user's list, the user may provide the relevant contact information for the recipient(s) at the time of selecting the destination location. At this time, the new recipients may be added to a currently-existing list, or a new list may be generated.

Selecting the designated recipient(s) for the destination may also be accomplished using the remotely accessible page 68. A non-limiting example of such a page is shown in FIG. 7. Once the user has elected that he/she wants to share the destination location (e.g., using the share destination function 142), the user is presented with a prompt, asking the user to either 1) select one or more designated recipients from a previously stored list, or 2) input one or more designated recipients. If the user elects to select a designated recipient from the list, the user will indicate as such via, e.g., a mouse click on the appropriate selection box 144. The user is then presented with the list of recipients from which the user may choose the designated recipient(s). Such recipients may be selected by clicking on the recipient's name. If, on the other hand, the user elects to input the designated recipient(s), the user will indicate as such by clicking the appropriate selection box 146. The user may then type the recipient's name and any other relevant contact information for the recipient in an input box presented on the remotely accessible page 68.

Once the user has determined to share his/her destination(s) and has selected the designated recipient(s), the destination location, the name(s) of the designated recipient(s), and the contact information for the designated recipient(s) are transmitted to the advisor 54, 54′ at the call center 46 using wireless carrier/communication system 17 (as shown by reference numeral 138).

The destination location is then shared with the designated recipient(s) (as shown by reference numeral 140). In an example, when the destination location is shared with the designated recipient, the call center advisor 54, 54′ pushes a message, via the communication system 17, to an electronic device of the designated recipient. Non-limitative examples of such electronic devices include another in-vehicle telematics unit 18, a cellular phone, a landline phone, a computer, a personal digital assistant (PDA), and/or the like, and/or combinations thereof. In some instances, the pushed message from the advisor 54, 54′ may appear as a prompt presented on the display screen of the designated recipient's electronic device indicating that the destination location, and any additional information pertaining to the destination location (e.g., navigation instructions), is available for downloading. In another example, the designated recipient may receive a phone call from the advisor 54, 54′ with a verbal message relaying the shared destination location and any other information pertaining to the shared destination location. In still another example, the recipient may receive an email with the shared information. It is to be understood that such messages may also indicate to the recipient the user who has shared the destination location/information.

In another example, when the destination location is shared with the designated recipient(s), the call center advisor 54, 54′ identifies that a destination location has been shared with the recipient in the designated recipient's profile. In this example, the designated recipient is a subscriber to the same service as the user, and thus has an account or profile that is accessible to the advisor 54, 54′. The advisor 54, 54′ pings or otherwise flags the profile of the designated recipient(s) using a central computer system operated by the call center advisor 54, 54′. The flag indicates to any advisors 54, 54′ accessing the recipient's profile that the information has been shared, and that the recipient should be notified of such shared information immediately or the next time he/she contacts the call center 46. In this example, when the user identifies the designated recipient, he/she may also indicate whether he/she would like the information to be marked in the recipient's profile as urgent. If such information is marked as urgent, the advisor 54, 54′ may push the information to the recipient rather than flagging the profile. It is to be further understood that in this example, the recipient may be aware of the shared destination service, and may mark his/her profile with an indication of whether he/she would like such messages pushed to him/her. If the recipient marks his/her profile as declining the pushing of messages, the call center advisor 54, 54′ will simply flag the profile as having received shared information, but will not push the message to the recipient until the recipient contacts the call center 46, regardless of the wishes of the user.

It is to be understood that that other information, in addition to the destination location itself, may also be shared with the designated recipient(s). For example, the user may wish to share navigation instructions (e.g., requested verbally or via the remotely accessible page 68 as described hereinabove), his/her then-current position, and/or the amount of time it would take him/her to get to the destination location.

Furthermore, the user and the designated recipient may use the shared destination function to share then-current information pertaining to the selected destination. For example, the user may designate one or more recipients and have a message pushed to such recipients regarding the destination location. As a non-limiting example, the message may include the address for the destination location, and that the user is currently in route to the destination location. Other information that may be pushed includes navigation instructions, rendezvous points and/or times, estimated times of arrival, or the like. Upon receiving the destination location information, the recipient(s) may be reply to the user (and any other recipients receiving the particular message) indicating a request for navigation instructions, that they are also in route, their estimated time of arrival, or the like. Such communication may take place through the call center 46, or the recipients may contact each other directly after the initial message has been pushed by the call center advisor 54, 54′.

While several examples have been described in detail, it will be apparent to those skilled in the art that the disclosed examples may be modified. Therefore, the foregoing description is to be considered exemplary rather than limiting.

1. A system for sharing destinations, comprising:
a communications device for transmitting a destination location and a designated recipient of the destination location, at least one of the destination location or the designated recipient being selected by a user, wherein the designated recipient is a person or entity other than the user; and
a call center including:
an advisor configured to receive the destination location and the designated recipient of the destination location;
a communications system operable by the advisor for pushing a message to an electronic device of the designated recipient regarding the destination location; and
a central computer system operable by the advisor for identifying in a profile of the designated recipient that the destination location has been shared.

2. The system as defined in claim 1 wherein the communications device is selected from an in-vehicle telematics device and a computer located remote from the call center that is capable of accessing a remotely accessible page selectively operatively connected to the call center.

3. The system as defined in claim 2 wherein the remotely accessible page includes:
a first activation option for initiating a navigation function; and
a second activation option for initiating a shared destination function.

4. The system as defined in claim 1, further comprising a database for storing the profile of the designated recipient.

5. The system as defined in claim 1, further comprising a navigation system operatively connected to at least one of the communications device or the call center and configured to generate navigation instructions to the destination location, wherein the navigation instructions are at least one of pushed with the message to the electronic device or stored in the designated recipient's profile.

6. The system as defined in claim 1, further comprising a list of recipients stored in at least one of the communications device or at the call center.

7. A system for sharing destinations, comprising:
a server;
a remotely accessible page operatively connected to the server, the remotely accessible page including:
a first activation option for initiating a navigation function utilizing i) no starting point, ii) a starting point entered by a user, or iii) a starting point obtained by the system from a vehicle; and
a second activation option for initiating a shared destination function; and
a call center advisor configured to receive information, input via the remotely accessible page, pertaining to the navigation function and the shared destination function, and to at least one of alert a profile of a designated recipient with a shared destination or push a message to an electronic device of the designated recipient of the shared destination, wherein the designated recipient is a person or entity other than the user.

8. The system as defined in claim 7 wherein the information pertaining to the shared destination function includes a distribution list including the designated recipient.

9. The system as defined in claim 7 wherein the information pertaining to the navigation function includes navigation instructions to the shared destination.

10. The system as defined in claim 9 wherein the information pertaining to the navigation function further includes a then-current position of a user of the remotely accessible page; an estimated time of arrival of the user, the designated recipient, an other designated recipient, or combinations thereof to the shared destination; a rendezvous point; a rendezvous time; or combinations thereof.

11. The system as defined in claim 7 wherein the shared destination function includes a prompt regarding sharing a destination, and a prompt regarding i) selecting the designated recipient from a previously stored list or ii) inputting the designated recipient via the remotely accessible page.

12. The system as defined in claim 11 wherein the previously stored list contains recipient contact information selected from a URL, a phone number, a user name, an email address, or combinations thereof.

13. The system as defined in claim 11, further comprising:
a call center with which the server is associated; and
a database located at the call center which stores a profile containing the previously stored list.

14. The system as defined in claim 7, further comprising a navigation system in operative communication with the remotely accessible page and configured to generate navigation instructions in response to initiation of the navigation function, wherein the navigation instructions are at least one of pushed with the message to the electronic device or stored in the designated recipient's profile.

15. The system as defined in claim 7 wherein the electronic device is selected from an in-vehicle telematics unit, a cellular phone, a landline phone, a computer, a personal digital assistant, or combinations thereof.

16. A method for sharing destinations, the method comprising:
selecting, via a user, a destination location;
determining, via the user, a designated recipient for the destination location;
transmitting, via a communications device, the destination location and the designated recipient of the destination location to a call center advisor; and
sharing, via the call center advisor, the destination location with the designated recipient by either pushing a message to an electronic device of the designated recipient regarding the destination location or identifying in a profile of the designated recipient that the destination location has been shared, wherein the designated recipient is a person or entity other than the user.

17. The method as defined in claim 16 wherein selecting the destination location and determining a designated recipient for the destination location are accomplished using a communications device selected from an in-vehicle telematics device and a computer located remote from the call center that is capable of accessing a remotely accessible page selectively operatively connected to the call center.

18. The method as defined in claim 17 wherein selecting the destination location is accomplished using the remotely accessible page, and includes utilizing a first activation option for initiating a navigation function utilizing i) no starting point, ii) a starting point entered by a user, or iii) a starting point obtained by the system from a vehicle.

19. The method as defined in claim 17 wherein determining the designated recipient is accomplished using the remotely accessible page, and includes:
indicating, via a prompt regarding sharing the destination location, that the destination location should be shared; and
either selecting the designated recipient from a previously stored list or inputting the designated recipient via the remotely accessible page.

20. The method as defined in claim 19 wherein prior to selecting the designated recipient from a previously stored list, the method further comprising:
creating a list of contacts; and
storing the list of contacts in a user account that is accessible via the remotely accessible page.

21. The method as defined in claim 17, further comprising:
generating navigation instructions to the destination location; and
sharing the navigation instructions with the designated recipient.

22. The method as defined in claim 17, further comprising sharing at least one of a then-current position of a user of the remotely accessible page; an estimated time of arrival of the user, the designated recipient, an other designated recipient, or combinations thereof to the shared destination; a rendezvous point; a rendezvous time; or combinations thereof with the designated recipient.
